(19) United States
(12) Patent Application Publication
(10) Pub. No.: US 2017/0174502 A1
(43) Pub. Date: Jun. 22, 2017

(54) Method and System for Discharging Flexitank Viscous Material

(71) Applicant: Braid Logistics North America, LLC, New Orleans, LA (US)

(72) Inventor: Christopher White, Denham Springs, LA (US)

(21) Appl. No.: 15/452,192

(22) Filed: Mar. 7, 2017

Related U.S. Application Data
(63) Continuation of application No. PCT/US15/48885, filed on Sep. 8, 2015.
(60) Provisional application No. 62/048,051, filed on Sep. 9, 2014.
(60) Provisional application No. 62/197,805, filed on Jul. 28, 2015.

(51) Int. Cl. B67D 7/80; F28F 27/02

(52) U.S. Cl. CPC B67D 7/80; F28F 27/02; F28F 2250/06

(57) ABSTRACT

A discharge system that includes a flexitank having product stored therein and a discharge port. The discharge port is selectively fluidly connected to a first or second heat exchanger input port. The first heat exchanger has an outlet port that is in selective communication with either a second heat exchanger input port, or a discharge location. The second heat exchanger has an outlet port in selective fluid communication with discharge location. The first heat exchanger transfers heat to product flowing through the first heat exchanger; and the second heat exchanger removes heat from product flowing through the second heat exchanger.

### CROSS-REFERENCE TO RELATED APPLICATIONS

This application is a continuation of PCT/US15/48885, filed on Sep. 8, 2015, which application claims the benefit under 35 USC 119(e) of U.S. Provisional Application No. 62/048,051, filed on Sep. 9, 2014; and U.S. Provisional Application No. 62/197,805, filed on Jul. 28, 2015, all of which are incorporated by reference herein in their entirety.

### BACKGROUND

Viscous materials, such as syrups, vegetable oils, mineral oils, fruit mashes and juices, and pepper mash, are often transported via a large flexible bladder bag, commonly referred to as a flexitank. General descriptions of flexitanks are included in WO 2001070598, WO 1998013276 A1 and U.S. publication US 20100122981, all incorporated by reference. These filled bladders are often shipped via intermodal containers or shipping containers. The flexitank usually has a sealable input port and a sealable outlet port, but the input and outlet port may be combined. Some flexitanks include additional ports, for instance, aeration ports. During the course of transport, portions of the contents in the flexitank may settle or precipitate out of solution, or develop crystals that are undesired in the finished product, or, due to ambient temperatures, increase in viscosity and become more difficult to handle and discharge upon arrival at the destination. On arrival at the destination, the contents are removed from the flexitank. This generally entails opening the intermodal container (a metal box surrounding the flexitank), attaching a discharge hose to the outlet port, and discharging the materials, either by gravity flow or with the assistance of a pump.

For materials that precipitate, crystalize, solidify or settle out, a non-flowable or slow flowable layer may be present near the discharge port, making removal of the materials difficult. Several processes have been developed to deal with this non-flowable or slow flowable layer. The techniques or processes involve either mixing the materials in the flexitank with a mixer (air injection) or heating the materials in the flexitank. One heating technique is to place a heating pad underneath the flexitank prior to loading. At the discharge facility, heated fluids are flowed through the heater pad, thereby transferring heat to the material via conduction. See U.S. Pat. No. 5,884,814, incorporated by reference. A second method is to insert a heat exchanging surface (a heated probe) into the interior of the container via injection ports positioned on the top of a flexitank, to directly heat the materials by contact with the heated probe. See U.S. Pat. No. 8,746,328 issued to the Applicant of this Patent Application hereby incorporated by reference. A variation of use of a heating probe is disclosed in U.S. Pat. No. 8,734,005, hereby incorporated by reference, where a heating probe (a heat exchanging surface) is positioned within the interior of the flexitank through the outlet of the flexitank prior to filling of the flexitank. At the discharge site, heated fluid is circulated through the heating probe, and the heated materials are discharged though an opening in the heating probe.

Each of the above solutions has limitations; heat transfer from the heating blanket into the contents of the flexitank is very slow and inherently inefficient, and while the use of heating probes in the interior raises the material temperature faster, putting probes in the interior of the flexitank is problematic. For viscous material that form crystals, but remain flowable, such as high fructose corn syrups, the above methods are inefficient.

A more efficient process and system is needed to transfer heat to the fluid materials in the flexitank.

### DESCRIPTION OF THE DRAWINGS

FIG. 1 is a schematic showing one embodiment of the invention.

FIG. 2 is the schematic of FIG. 1 showing flow paths for recirculation only.

FIG. 3 is the schematic of FIG. 1 showing flow paths for heat and discharge .

FIG. 4 is the schematic of FIG. 1 showing flow paths for heat, partial recirculation, partial discharge.

FIG. 5 is the schematic of FIG. 1 showing flow paths for cooling and discharge.

FIG. 6 is the schematic of FIG. 1 showing flow paths for heat, then cool, then discharge.

FIG. 7 is a schematic showing one embodiment of a flexitank for use with the heating system.

### DETAILED DESCRIPTION OF THE INVENTION

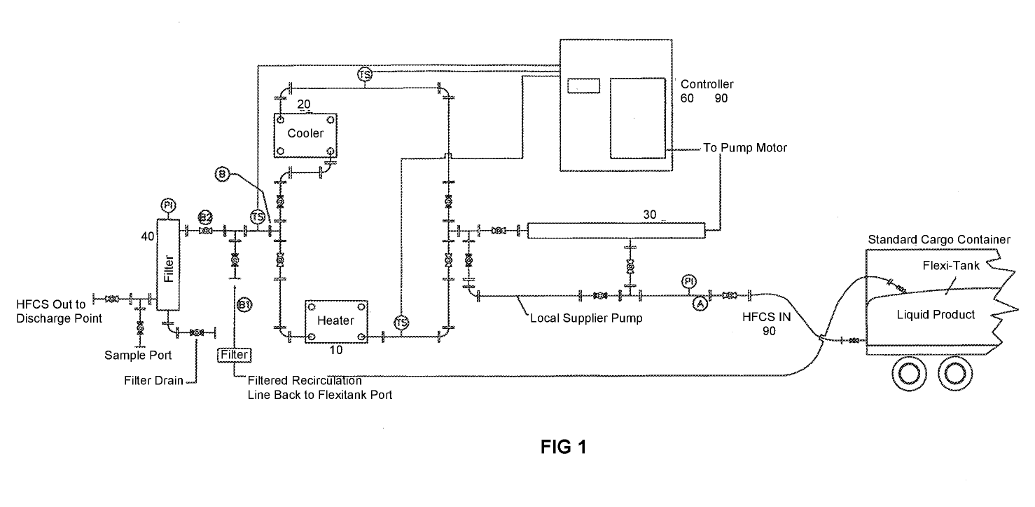

The invention preferably is constructed or designed as a self-contained skid mounted discharge system for portability. External supplies for a self-contained discharge system can include external power, a source of heated fluid, and a source of chilled or cooled fluid. Alternatively, a portable steam generator can be included for use with the heat exchanger. One embodiment of the inventions is shown in schematic form in FIG. 1, and includes a first heat exchanger 10, a second heat exchanger 20, a pump 30, a filter 40, and a control unit 60. Various valves and sensors are also indicated (TS=temperature sensor; PI=-pressure sensor) preferably each communicating with the control unit 60. The valves may be operated via the control unit controller (if electrically controlled valves), or manually operated. Flow lines are also shown. Pump 30 may be skid mounted or supplied at the discharge facility. Multiple pumps may be used in the system, but this is not preferred as it adds to the complexity of the system.

A first flow line A is connected to the discharge valve of the flexitank (not shown) to a pump 30. When the pump 30 is activated (preferred pumps may be sanitary pumps), the product exits the flexitank, flows through the pump and may be directed to first heat exchanger 10, or second heat exchanger 20, by operation of the appropriate valves. Heat exchanger 10 is intended to raise the temperature of the input product (when operational), while heat exchanger 20 is intended to lower the temperature of the input product when operational (heat exchanger 20 is a cooler). For low heat transference exchangers, each exchanger could be a plurality of exchangers in series. The efficiency of heat transference of the system can be modified by changing the temperature of the heating fluids (heated water or steam, for instance) or the pressure (and hence rate of flow) of the heating fluid through the heat exchanger, or the product flow rates though the exchangers (for instance by modifying the pump rate).

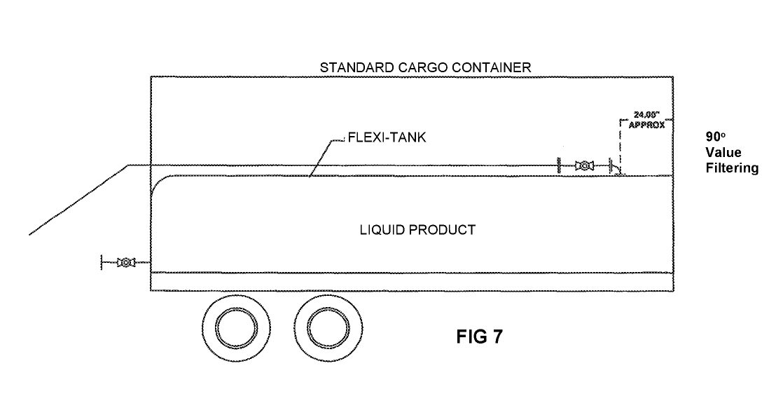

When the system is first started up, product will flow from the flexitank, through heat exchanger 10, to raise the temperature of the product. Exiting the heat exchanger 10, product can be directed to the second heat exchanger cooler 20, or to line B (or to both). Cooler 20 can be used with a cooling fluid, such as water or chilled water, for instance. Line B leads to two flow paths, line B1, which is a recirculation line, and line B2, which is connected to the discharge line C. Line B2, the recirculation line, is a flow line that connects back to the flexitank, such as through a flowline that attaches to a flexitank inlet port, or flexitank mixing port, or some other port on the flexitank. Preferably, the recirculation flowline attaches to the flexitank through a recirculation valve body located at a port on the top of the flexitank, at the end of the flexitank opposite the discharge valve. See FIG. 7. Preferably, the recirculation valve is positioned in the flexitank prior to the tank being filled. The purpose of the recirculation line is to allow heated product to be returned to the flexitank, to help raise the temperature of the product in the flexitank. One preferred flow path for recirculation is to pull from the discharge port (located near the bottom of the tank near the container doors) and send to the heat exchanger, and to recirculate heated fluids to the top end of flexitank near the closed end of the container. This recirculation path is preferred to more efficiently and evenly distribute heat throughout the product. The recirculation path could be reversed (e.g. pull from the top rear of the flexitank and recirculate to the front bottom). Other recirculation paths could be used depending on the particular flexitank construction and configuration. When the heating process is first started, recirculation may be the preferred first flow path, or alternatively partial recirculation and partial discharge. The flow path selected can depend, for instance, on the temperature of the product exiting the first heat exchanger 10, and the temperature of the product on exiting the flexitank (i.e. the flowable fluids temperature at the inlet of the heat exchanger) and the severity of crystallization or viscosity issues.

The recirculation line may be connected to the flexitank at the initial shipping point, and the filled flexitank shipped with a recirculation line in place for convenience. For instance, the terminal end of the recirculation line (the end remote from the recirculation port on the flexitank), may be positioned near the discharge point near the front of the flexitank (the “front” of the flexitank faces the doors of the shipping container) to allow ease of connection to the portable heat exchange system. In this instance, the recirculation valve may be placed in-line with the recirculation line and located near the front of the flexitank.

The goal is to preferably raise the temperature of the product to a desired first temperature reducing crystallization, viscosity, or both for discharge. For instance, one product often shipped in a flexitank is high fructose corn syrup (HFCS) such as HFCS 55 (approximately 55% fructose and 45% glucose), a material heavily used in the food and drink industries. Corn syrups, including HFCS 55, HFCS 42 (approximately 42% fructose and 58% glucose) and other variation, can form crystals within the fluid the fluid cools and drops in temperature (during shipping, for instance). Crystals are not desired in the discharged HFCS product. One preferred temperature for discharge of HFCS 55 is about 98 degrees Fahrenheit. However, this temperature is not generally sufficiently high to melt or break corn syrup crystals. A temperature of about 120 degrees Fahrenheit is needed to quickly break large HFCS 55 crystals. However, raising the temperature of the HFCS to 120 degrees may adversely impact product coloration, for instance, causing yellowing of the HFCS product. While it is desirable to raise the temperature of the corn syrup to a temperature sufficient to melt the crystals, the temperature rise can be made to a less elevated temperature (for instance, to 105 degrees Fahrenheit) and maintained for a sufficiently long period to break or melt crystals over the extended period of time. That is, at a lower elevated temperature, it may take longer to fully melt entrained crystals. The desired temperature rise in the product will depend upon multiple factors, including the severity of crystallization, the type or size of crystals and the residence time (the length of time) the product will remain at an elevated temperature.

In the case of corn syrup, if the heat exchanger 10 has sufficient heat exchange efficiency, the product flowing out of the heater 10 may be at a temperature sufficient to melt entrained product crystals in a single pass. In this event, the heat exchanger 10 output product may be too hot for the preferred discharge temperature of 98 degrees Fahrenheit. Consequently, the product flow may be directed for recirculation, or to the cooling heat exchanger 20 for discharge, or a combination of recirculation and cooling/discharge. The selection to recirculate may be dependent on the product temperature entering the heat exchanger 10. For instance, if the inlet temperature is close to, or above the desired discharge temperature; then cooling only may be selected. If the inlet product temperature is far from the desired output temperature, then recirculation only may be desired. The selection will depend in part on the heat transference efficiency and product flow rates through the exchanger 10.

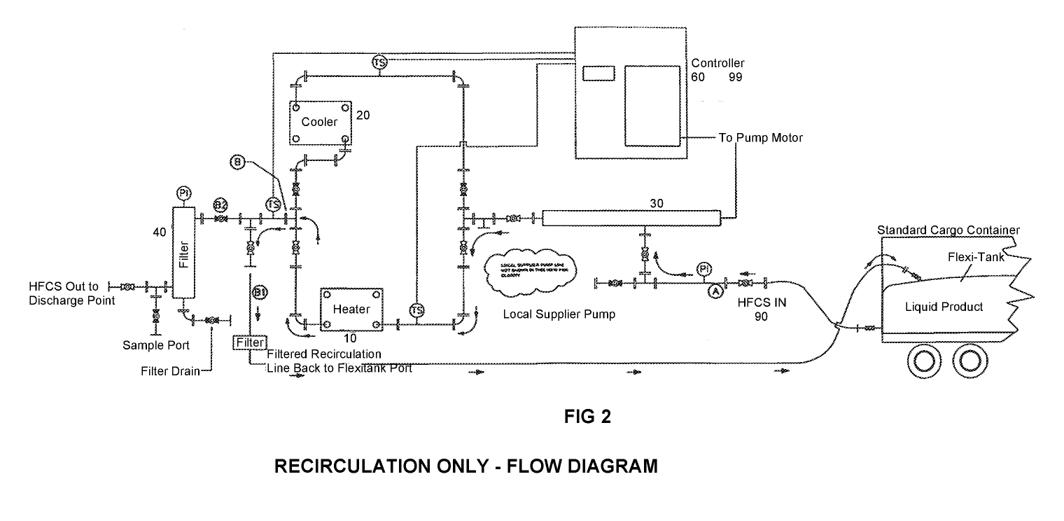

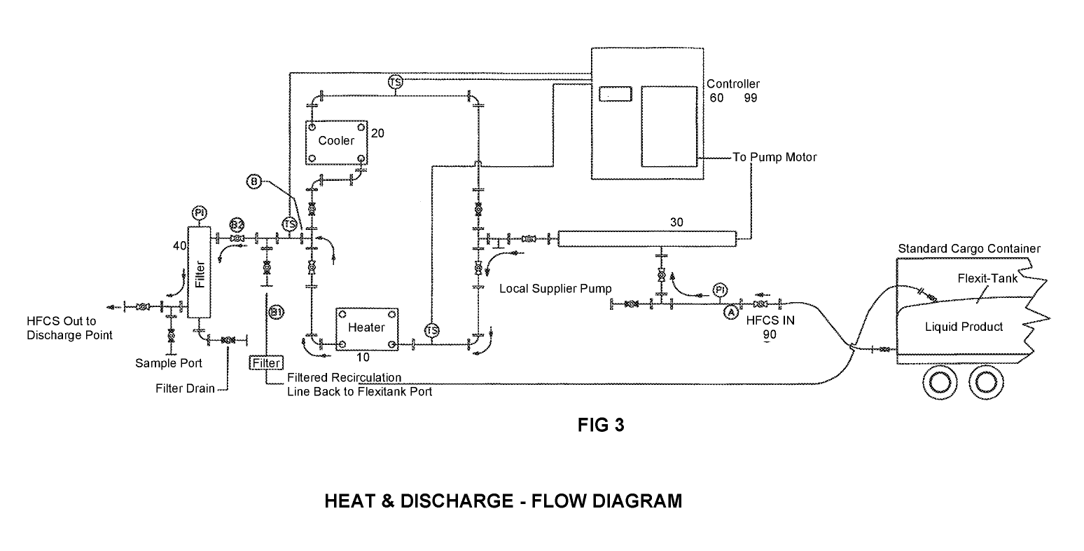

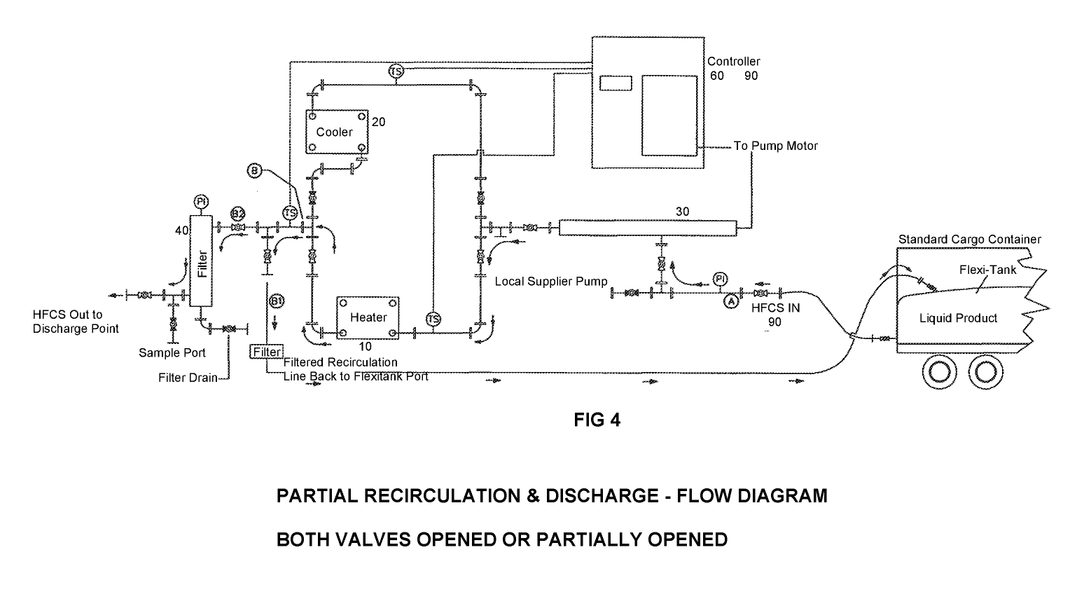

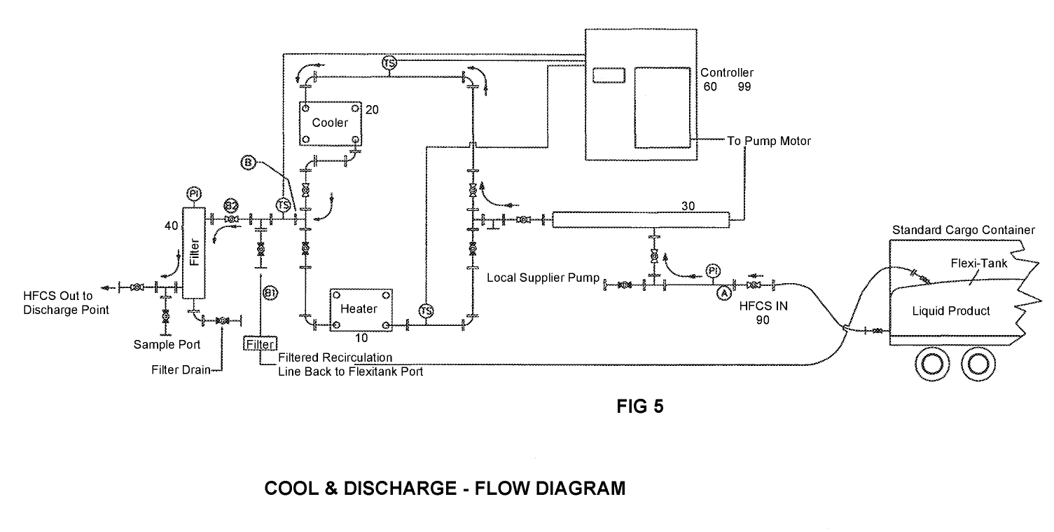

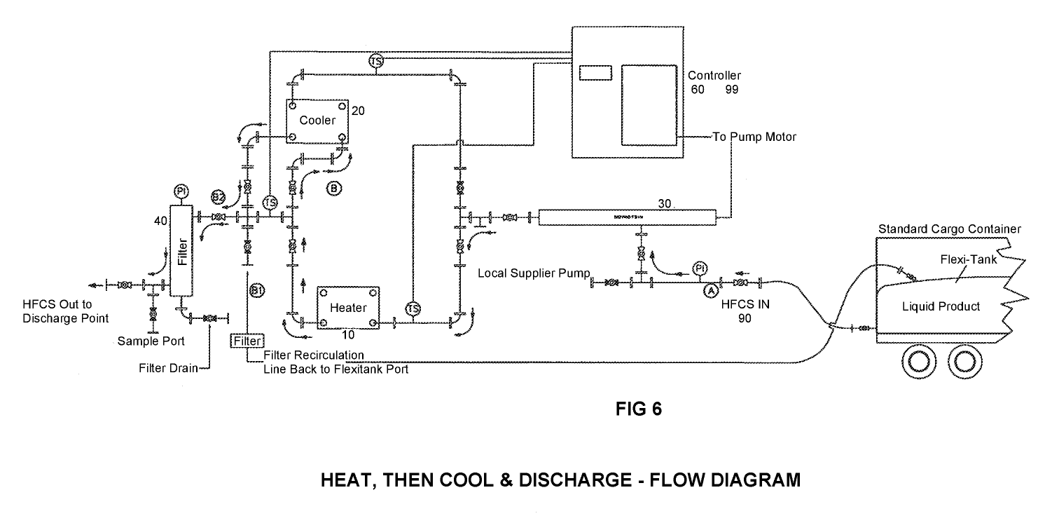

Other flow paths through the system are possible. For instance if the product needs to be maintained at a high temperature for a long residence time to break or dissolve crystals, then recirculation may be used until the product exiting the flexitank is at or above the desired crystal breaking temperature. In this case, recirculation flows may be slowed or stopped, or continued with the heat exchanger 10 shut off. Flow could then be restarted after the needed residence time is achieved, with product then flowing through the cooler (with possible recirculation) if needed or desired, or directly to discharge. The combinations of heating, cooling and recirculation flows can be custom designed for the specific product. Several of many possible flow paths through the system embodiment of FIG. 1 are shown in FIGS. 2-6. For instance, if the system is initially set to heat and recirculate the heated product, the system can be run in the heating/recirculation mode until the desired temperature (for instance, measured at the input to the heat exchanger) is achieved. The heating system can then be shut down and recirculation stopped, to let the product slowly cool to a lower temperature. This flow path allows the product to be maintained at an elevated temperature for an extended period of time. For instance, the HFCS product may be heated at a first location. When the desired temperature is reached, the heating system may be shut down and disconnected, and the intermodal container//flexitank, with heated product, may be transported to a second location for later discharge. That is, the product is not discharged through the system. Also shown in FIG. 1, a filter is preferably positioned on the output line prior to product discharge, and an optional filter is placed in the recirculation line. For corn syrup product, a 50 micron sock filter has been utilized as this size filter will capture many HFCS product crystals. For the recirculation line recirculating heated product, crystals captured by a filter on the recirculation line will be exposed to additional heated product flowing over the captured crystals. This heated product provides additional opportunity to melt or break the filter captured crystals in an efficient manner. The surface area of the filter should be large enough to maintain flow through the system.

Also shown in FIG. 1 is a control system 99 that is in communication with various sensors, and contains an optional variable frequency drive to control the throughput of the pump. Control system may include a processor or PLC, and be in communication with various valves used in the system, and be able to automatically control valve position. For known product, the sequence desired (e.g. heat/ recirculate/cool/discharge; or heat/recirculate/discharge, or heat/recirculate or other combination) can be determined in advance and coded into the controller. Decisions on when the controller should act to change the state of the system can be made based on sensor readings input to the controller (temperature, pressure, or pump rate) and/or prior stored recorded sensor readings (e.g. the history of the process for the particular flexitank). This allows the discharge process to be automated, using the known viscosity/temp characteristics of the product, and with sensors values input to the controller (e.g. temperatures and pressures), and can include modification of the pumping rate, the heating and cooling transference parameters based on a prior programmed sequence. For instance, when the heated product reached the desired temperature, the controller can be configured to shut down or deactivate the first heat exchanger 10. Alternatively, the controller could be configured to deactivate the heat exchanger, an operated valves to allow product to be discharges, or to shut down both the heat exchanger 10 and system pump, or other variations.

The system as described, can be used for a variety of products such as inks, oils, paints, and flowable foodstuffs (e.g. mashes, syrups, sweeteners, oils. fruit extracts, juices and wines). The system, as shown in FIG. 1, includes an alternate flow path to a separate pump, such as a pump located at the discharge facility. The system can also include a skid mounted steam generator for the heat exchanger 10, to create more complete system.

The system as described can be modified to eliminate the recirculation line if the outputs of the heat exchangers meet the desired temperature criteria (heat exchanger raises the product to the first desired temperature) and/or cooler (heat exchanger 2) lowers the temperature of product exiting the first heat exchanger to a desired discharge temperature, if cooling is desired. The second heat exchanger (the cooler) may be eliminated if cooling is not needed or desired. Additionally, the recirculation line may or may not be desired.

The system also employs a flexitank, which are well known in the industry. However, for recirculation, the desired flexitank may have a port on the top rear of the tank, where the port terminates in a valve for a recirculation line. Alternatively, the recirculation port may be located elsewhere on the flexitank,

The prior art heating methods, such as the heating pad methods, can require 24 hours or longer to raise the temperature of, for example, HFCS 55 in a 16,000 liter flexitank, from about 96 degrees to about 105 degrees Fahrenheit. The present system, pumping HFCS 55 at about 80 gal/min through a heat exchanger, (a plate exchanger with inlet design temperatures of 230 degrees Fahrenheit designed to handle 50 GPM of heated fluid) showed the following temperature profile for a filled 16,000 liter flexitank, using continuous recirculation of heated product:

| time | inlet temp | outlet temp |
|---|---|---|
| 11:20 | 96.0 | 104.0 |
| 11:35 | 98.0 | 106.0 |
| 11:50 | 98.0 | 108.0 |
| 12:05 | 100.0 | 110.0 |
| 12:20 | 100.0 | 112.0 |
| 12:35 | 100.0 | 116.0 |
| 12:50 | 102.0 | 118.0 |
| 13:05 | 103.0 | 120.0 |
| 13:20 | 104.0 | 122.0. |

As can be seen, the system raised the inlet temperature (product entering the heat exchanger, e.g., the material leaving the flexitank) from 96 degrees to 104 degrees Fahrenheit in about two hours versus 24 hours for the prior art heating method. These results were obtained using portable steam generating equipment of limited capacity as the heat source for the heat exchanger. Even more efficient heating times could be obtained if a larger capacity steam source was used as the heat source for the heat exchanger, or a larger capacity heat exchanger.

1. A discharge system comprising a flexitank for storing flowable product therein, said flexitank comprising a flexible bladder having a valved discharge port, and a first heat exchanger and a second heat exchanger both located remotely from the flexitank, said discharge port selectively fluidly connected to an input port on the first heat exchanger or a input port on the second heat exchanger; said first heat exchanger having an outlet port in selective communication with said second heat exchanger input port and a discharge location; said second heat exchanger having an outlet port in selective fluid communication with said discharge location; said first heat exchanger configured to transfer heat to product flowing through said first heat exchanger; said second heat exchanger configured to remove heat from product flowing through said second heat exchanger; and a pump, said pump operatively connected to said system to pump product in the flexitank to the first heat exchanger.

2. The discharge system of claim 1 further having a recirculation line, one end of said recirculation line in fluid communication with said flexitank, the other end of said recirculation line in selective fluid communication with said outlet port of said first heat exchanger or said outlet of said second heat exchanger.

3. The discharge system of claim 2 having a first, second and third temperature sensors; said first temperature sensor positioned to measure the temperature of product in said system near said discharge port; said second temperature positioned to measure the temperature of product in said system near said outlet port of said first heat exchanger; and said third temperature sensor positioned to measure the temperature of product in said system near said outlet port of said second heat exchanger.

4. A discharge system comprising a flexitank for storing flowable product therein, said flexitank comprising a flexible bladder having a valved discharge port; a first heat exchanger located remotely from said flexitank, said discharge port fluidly connected to an first heat exchanger input port; said first heat exchange configured to transfer heat to product flowing through said first heat exchanger, said first heat exchanger further having a discharge line said discharge line having a filter therein.

5. A method of discharging a flowable material from a system comprising
a flexitank, having a valved discharge port and a recirculation port, a first heat exchanger located remotely from the flexitank but in fluid communication with the discharge port and the recirculation port of the flexitank; and a pump operatively connected to said system to pump product in the flexitank to the first heat exchanger; the method comprising the steps of
(a) pumping material from the valved flexitank discharge port to an input port on the remotely located first heat exchanger, said first heat exchanger operating to raise the temperature of said flowable materials passing there through;
(b) pumping heated flowable materials from an outlet port on the first heat exchanger into the flexitank;
(c) continuing steps (a) and (b) until said heated flowable materials reaches a desired first temperature.

6. The method of claim 6 where the desired first temperature is measured near the inlet port of the heat exchanger or near the valved discharge port of the flexitank.

7. The method of claim 6 wherein said flowable material comprises high fructose corn Syrup.

8. The method of claim 7 wherein the desired first temperature in in the range of 98 degrees Fahrenheit to about 120 degrees Fahrenheit.

9. A discharge system comprising a flexitank for storing flowable product therein, said flexitank comprising a flexible bladder having a valved discharge port, said discharge port fluidly connected to an input port on a first heat exchanger; said first heat exchanger having an outlet port in selective fluid communication with a recirculation line and a discharge line, the recirculation line further in fluid communication with a valved recirculation port on the flexitank, said first heat exchanger configured, when active, to transfer heat to product flowing through said first heat exchanger, said system further including a pump, configured to pump materials from the flexitank to the first heat exchanger; said discharge system further comprising a controller and a temperature sensor, the temperature sensor in communication with the controller, the controller configured to deactivate the first heat exchanger when the temperature, as measured by the temperature sensor, is a desired first temperature.

10. The system of claim 9 further having a filter in communication with the recirculation line.

11. The system of claim 9 wherein the controller is further configured to select fluid communication from said output valve on the first heat exchanger with the recirculation line when the temperature, as measured by the temperature sensor, is a below a desired second temperature.

12. The system of claim 9 wherein the controller is further configured to select fluid communication from said output port of the first heat exchange with the discharge line when the temperature, as measured by the temperature sensor, is at or above a third desired temperature.

13. The system of claim 12 further comprising a second heat exchanger configured to remove heat from product flowing through said second heat exchanger, said second heat exchanger having an input port in fluid communication with the discharge line.

14. A method of discharging a flowable material from a system comprising
a flexitank, having a valved discharge port and a recirculation port, the method comprising the steps of
(a) pumping material from the valved flexitank discharge port;
(b) checking the temperature of said pumped material
(c) if said temperature exceeds a first predetermined value proceed to step (f),
(d) raise the temperature of said pumped material to produce a heated material;
(e) pump said heated material into the interior of the flexitank through the recirculation port;
and repeat steps (a) though (d);
(f) pump material from the interior of said flexitank from the valved flexitank discharge port, the and return said pumped material into the interior of the flexitank through said recirculation port;
(g) repeat step (f) until either a predetermined period of time or until said pumped material reaches a second predetermined temperature;
(h) pump material from the interior of said flexitank from the valved flexitank discharge port, and remove heat from said pumped material to produce a cooled material;
(i) measure the temperature of the cooled material;
(j) if the temperature of the cooled material is greater than third predetermined temperature pump said cooled material into the interior of the flexitank through the recirculation port;
and repeat steps (h) though (j);
(k) either (I) pump said cooled material into a discharge container or (II) cease pumping.
